(19) United States
(12) Patent Application Publication
(10) Pub. No.: US 2007/0084526 A1
(43) Pub. Date: Apr. 19, 2007

(54) Tool arrangement for gripping in a gripping table

(76) Inventor: Uwe Radermacher, Weibern (DE)

Correspondence Address: EVEREST INTELLECTUAL PROPERTY LAW GROUP, P. O. BOX 708, NORTHBROOK, IL, 60065, US

(21) Appl. No.: 11/544,310

(22) Filed: Oct. 5, 2006

(30) Foreign Application Priority Data
Oct. 5, 2005 (DE) 102005047655.4

(51) Int. Cl. B25H 1/00; B27C 1/00

(52) U.S. Cl. 144/286.1; 144/286.5; 144/154.5

(57) ABSTRACT

A tool assembly with a gripper structure on the underside of a support plate for gripping between two jaws of a gripping table or the like. The jaws being in the same horizontal plane and at least one jaw is movable relative to the other jaw. The support plate supports on one side an electromotor drive assembly having a tool driven thereby. The support plate is a surface plate from whose downwardly facing underside the gripper structure and the electromotor drive extend so as to pass through the space between the two jaws.

### CROSS REFERENCE TO RELATED APPLICATION

This application claims priority of German Patent Application Number 102005047655.4, filed Oct. 5, 2005, which is incorporated by reference.

### BACKGROUND OF THE INVENTION

The invention relates to a tool arrangement with gripping means provided on the underside of a support plate, so that gripping can take place between two gripping members of a gripping table or the like, whereby the support plate supports on one side an electromotor drive mechanism, which works a driven tool mounted on the opposed side.

A tool arrangement is already known from U.S. Pat. No. 4,069,849. In this tool arrangement an electromotor drive arrangement is fixed in place by means of a holding plate on a beam-like gripping means. The holding plate, together with the electromotor drive apparatus, is secured, using securement screws, against the upper surface of the gripping means. The holding plate can be secured in various different positions against the gripping means, for example boreholes can be used along one side, and a sloping bore on the other. Through the bores and through the sloping hole the securement screws can be fixed. The electromotor drive apparatus is connected by a bayonet-joint closure to the holding plate. The tool, which is driven by the electromotor drive apparatus, projects through an opening in the holding plate. The tool points on this (the near) side to a holding plate, on which the gripping means is fixed. On the opposite side of the gripping means, flange-like projections are provided. They extend down sideward across the elongation direction of the gripping means. The gripping means, together with the electromotor drive apparatus, is clamped between two gripping arms of the gripping table. This results in the electromotor drive apparatus extending down from the upper side of the gripping table. The tool points in the direction of the upper side of the gripping table. Through the flange-like projection, the tool assembly can be so arranged between the two gripping beams that the gap between the holding plate and the gripping table upper surface corresponds to the material thickness. In order to adjust this height, a displacement element is laid on the one gripping beam of the workpiece, while on the other beam is laid a spacing element which has the same material thickness as the workpiece. The tool assembly is now so arranged between the two beams that the flange-like projection lies both on the workpiece and on the spacing element. Finally, the two gripping beams are so arranged that one of them is clamped between the two gripping beams. The spacer element can be removed and the tool assembly adjusted for the one material thickness of the one workpiece. Now several workpieces with the same material thickness can be worked. The holding plate serves simultaneously as a hold-down for the workpiece. The beam-like gripping means forms the stop for the workpiece. As mentioned above, the position of the workpiece with respect to the stop of the gripping means can be varied. For this, the holding plate together with the electromotor drive assembly must be secured with the securement screw in another position on the gripping means. This is provided by the above-mentioned bores and the sloping hole in the holding plate.

### SUMMARY OF THE INVENTION

An advantage of the present invention can be to further develop a tool arrangement of a similar species so as to provide advantages of use.

In an embodiment, the present invention provides that the support plate be a surface plate from whose downwardly directed underside the gripping means and the electromotor drive apparatus extend down in such a way as to pass through the space between the two gripping beams.

Preferably the support plate nearby forms its opposed elongate edges below the support surfaces, which, region-wise, lie flat against respective gripping beams. The support surfaces have approximately half the width of the gripping beam. The workpiece tool is preferably a milling cutter whose drive shaft extends through an open through-passage. The electromotor drive assembly is secured to the underside by means of loosenable securing means. The gripping means are preferably small blocks secured to the underside of the support plate. Each small block has a projection which connects below in the gripping location. Preferably there are in total four individual small blocks located at the comers of a theoretical rectangle. They indicate a section of a right-angle triangle. The small blocks are preferably made of plastic and are secured midway between two screws on the underside of the support plate. The projections are formed from two noses separated from one another. On the upper surface of the support plate there are provided workpiece guide stop means. These are adjustable and fixable with respect to the support plate. The through-openings of the workpiece guide stop are lockable with respect to a custom exhaust system. Below such a system is provided an opening in which an exhaust tube can be inserted.

Additional features and advanatages of the present invention are described in, and will be apparent from, the following Detailed Description of the Invention and the figures.

### BRIEF DESCRIPTION OF THE FIGURES

The invention will be more clearly explained, utilizing example embodiments, which illustrate:

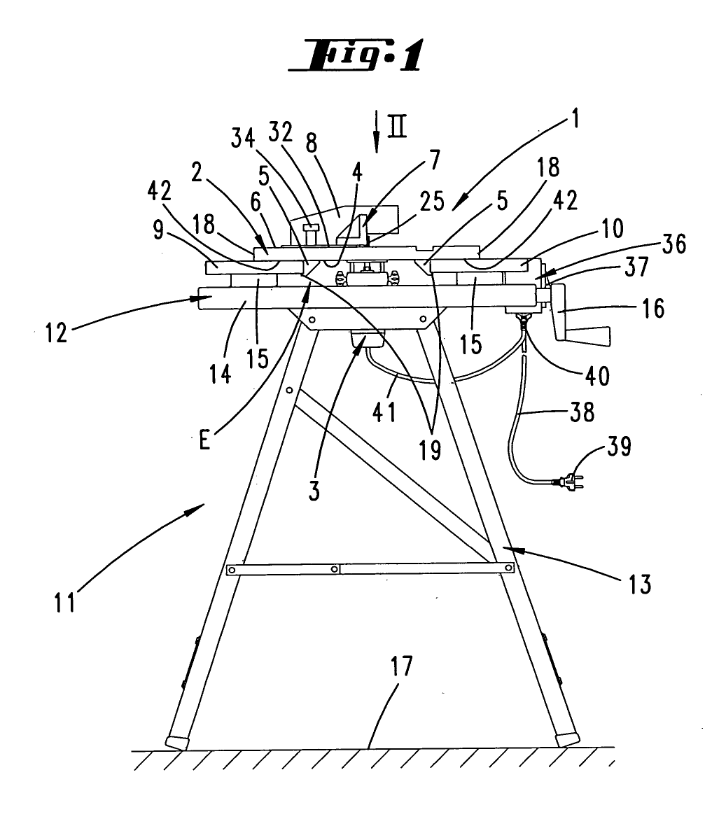

In FIG. 1 a side elevation of a tool arrangement,

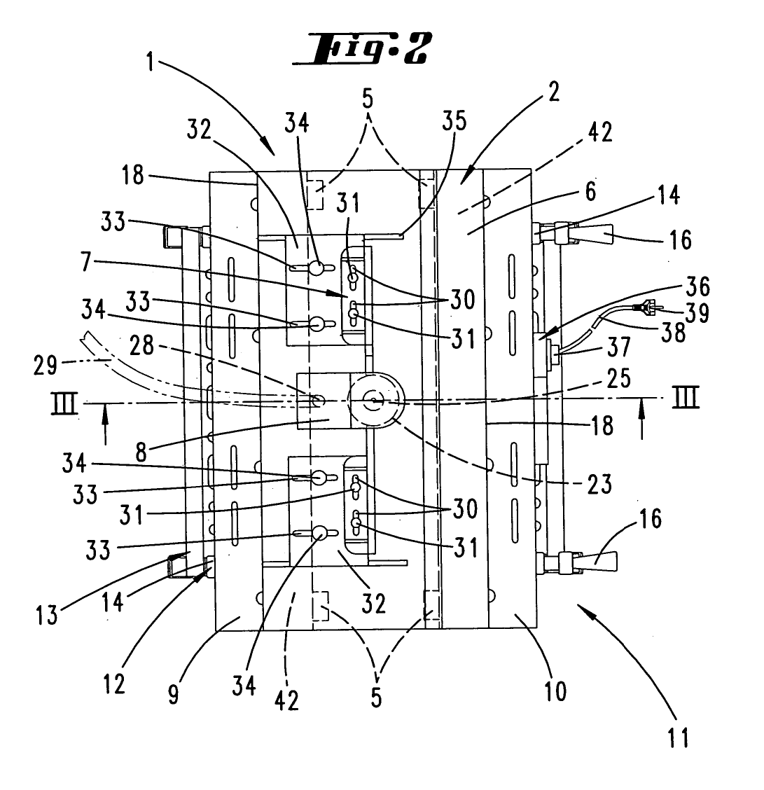

In FIG. 2 a top plan view corresponding to the direction II in FIG. 1, in which a dust (chip) exhaust tube is schematically shown,

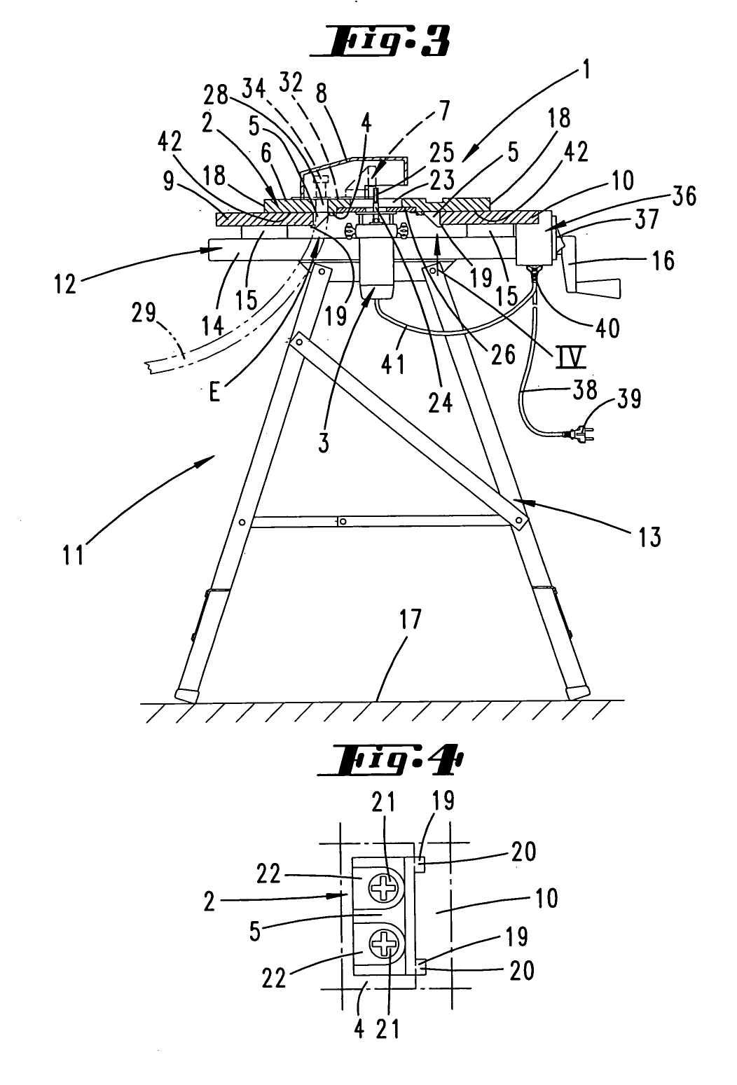

In FIG. 3 a section taken along the line III-III in FIG. 2, in which a dust exhaust tube is (again) schematically illustrated, and

In FIG. 4 a detail of the lower view of a gripping means corresponding to the sight direction IV of FIG. 3.

### DETAILED DESCRIPTION OF THE INVENTION

A tool assembly 1 consists essentially of a support plate, in particular configured as a surface plate 2, an electromotor drive assembly 3 which is provided on the underside 4 of the support plate, and gripping means E situated on the underside 4 of the surface plate 2. Furthermore, there are provided, on the upper side of the support plate 2, tool guide stops 7, along with a chip vacuum hub 8.

The tool assembly 1 is gripped between two jaws 9, 10 of a gripping table 11 of known construction. The gripping table 11 includes a clampable rack 12 having on its underside a support frame 13. The clampable rack 12 has two parallel extending bars 14. The bars 14 receive guide elements 15 from the jaws 9, 10. The jaws 9, 10, by way of the guiding elements 15, can be locked in various positions with respect to the bar 14. The guiding element 15 of the jaw 10 can, in known manner, run from a spindle which can be driven by a hand crank 16. This permits a continuously variable displacement of the jaw 10. By contrast, the jaw 9 can move only in stages. When the gripping table 11 is in its position of use, the upper surfaces of the jaws 9, 10 are parallel to the floor 17. The support frame 13 can be adjusted such that the frame is substantially parallel to the upper surface of the jaws 9, 10. In this configuration, the gripping table 11 can be stored while taking up little space.

On the underside 4 of the surface plate 2 the gripping means E is provided, assembled from four small blocks 5. These lead to a clearance for the long edge 18 of the support plate 2. As can be seen in FIG. 2, the four small blocks 5 are spaced one from the other, each at the corner of a theoretical rectangle. The small blocks 5 define the cross-section of a right-angled triangle. Further, the blocks 5 have projections 19. Each projection 19 of a block 5 is formed from two noses. The blocks 5 are mounted utilizing screws 21 on the underside 4 of the surface plate 2. In this manner the small block 5 defines two recesses 22. In each of the recesses 22 there lies a screw head of a screw 21. The screw shaft of the screw 21 extends through an elongate bore which is located in the small block 5. The projections 19 of the small block 5 engage, in the gripping position, the jaws 9, 10. The noses 20, which form the projections 19, are situated a distance from the underside 4 of the support plate 2 which is approximately the same as the material thickness of the jaws 9, 10. The small blocks 5 are preferably made of plastic.

The support plate 2 defines near the mid point a through-going opening 23. Through the through-going opening 23 projects the drive shaft 24 of a tool 25. The tool 25 is preferably a milling cutter.

The electromotor drive assembly 3 is secured, by way of a securement means 26, to the underside 4 of the support plate 2. The electromotor drive assembly 3 is mounted, for example, with screws to the securement means 26. The electromotor drive assembly 3 projects from the underside 4 of the support plate 2, whereby the tool 25 extends through the through-going opening 23 as far as the upper side 6 of the support plate 2.

The through-going opening 23 is engaged by a chip suction housing 8. The chip suction housing 8 simultaneously serves as finger protection, which prevents an operator from inadvertently reaching into the running tool 25. Below the chip vacuum housing 8 is provided an opening 28. A chip suction tube 29 can be pushed into the opening 28. The chip suction tube 29 is only schematically illustrated in FIGS. 2 and 3.

It can be seen in FIGS. 1 and 2 that tool guide detents 7 are provided on the upper side 6 of the support plate 2. The tool guide detents 7 have the form of an angle profile (see FIG. 1). In the shank which runs parallel to the support plate 2, there are provided, in sequence, two sloping holes 30 in the elongation direction of the jaws 9, 10. Through the holes 30 extend securement screws 31. By means of the securement screws 31, the tool guide detent 7 can be secured to a support plate 32. Through the hole 30 it is possible to shift the tool guide detent 7 in the elongated direction of the jaws 9, 10. The support plate 32 also has two elongate holes 33. The elongate holes 33 extend parallel with each other, and at right angles to the long direction of the jaws 9, 10. Through each elongate hole 33 there extends a fastening screw 34. The elongate holes 33 make it possible to shift the support plate 32 at right angles to the elongation direction of the jaws 9, 10. Utilizing the screws 34, the support plate 32 can be fixed in the desired position. The end of the support plate 32 which points away from the chip suction hood 8 is distorted. The distorted end of the support plate 32 extends into a guide slot 35. The guide slot 35 is accustomed to support plate 2 and extends at right angles to the long direction of the jaws 9, 10.

To the side of the jaw 10 between the two hand cranks 16 there is positioned a plug board 36. The plug board 36 can, for example, be secured to the jaw 10 utilizing screws. The plug board 36 has a switch 37. The switch 37 is positioned at right angles to the upper edge of the chip table. A cable 38 extends from the plug board 36. At the end of the cable 38 is provided a plug 39. Utilizing the plug 39, the plug board 36 can be connected with a plug box (not illustrated). This provides, on the underside of the plug board 36, a plug opening for a plug 40. The plug 40 is mounted on a cable 41 which is in turn connected with the electric motor drive assembly 3.

In what follows, the assembly of the example embodiment of the tool assembly on a chip table is described in greater detail.

In order to be able to mount a tool assembly, in accordance with the invention, on a chip table, the jaws 9, 10 are separated from each other sufficiently that the gap between the jaws 9, 10 is greater than the gap between the ends of the noses 20 of the two small blocks 5. Then the support plate 2, with its support surfaces 42 which lie between the elongate edges 18 and the small blocks 5, is laid on the jaws 9, 10. Each of the support surfaces 42 corresponds roughly to half the width of one jaw 9, 10. This causes the electromotor drive assembly 3 to extend into the space between the two jaws 9, 10. After the support plate 2 is positioned so that it lies close to the edges of the jaws 9, 10, the jaws 9, 10 can stretch around the support plate 2. Thereupon, utilizing the hand crank 16, the jaw 10 is shifted in such a way that the jaw 10 moves in the direction of the jaw 9. The gripping means E are clamped between the two jaws 9, 10. Then, the projections 19 grip around the jaws 9, 10. The support plate 2 is clamped between the jaws 9, 10. Finally, the plug 40 of the electromotor drive assembly 3 is inserted into the plug opening of the plug board 36. Now, the electromotor drive assembly 3 can, by way of the plug 37, be turned on and off. The cable 38 and the plug 39 permit a connection to the source of current. The electromotor drive assembly 3 can be activated through the switch 37 only if the switch on the electromotor drive assembly 3 is actuated. The plug board 36 makes possible an easier manipulation of the electric motor drive assembly 3.

With this embodiment of the tool arrangement 1, it is no longer necessary to space the electromotor drive assembly 3 from the upper edge of the jaws 9, 10 in such a way that a workpiece can be placed between them. With this arrangement, workpieces of varying material strength can be worked, without having to alter the workpiece arrangement 1. By way of the chip vacuum hub 8 the chips that are created from the working of the workpiece are directly led away through the chip vacuum tube 29. The chip vacuum tube 29 can, for example, be directly connected to a chip vacuum device. In this manner the user is the most protected from the generated chips.

Compared with the state of the art, the tool arrangement in accordance with the invention offers a simple way to drive a stationary miller (a router) from above. The mounting of the upper miller on the underside of the support plate 2 preferably takes place without clamping the support plate 2. In such case the components can be vertically aligned or turned upside down and set on the jaws 9, 10, so that the finger-protecting hub extends in the space between the jaws 9, 10. In this configuration an upper position for the workpiece tool 25 is also possible.

It is further important that the entire drive assembly remain connected, in the event that the workpiece assembly 1 is removed from the gripping table 11. It is possible to use a variety of tools 25 together with a variety of support plates 2. This will merely require the support plate 2 to be exchanged for the previously installed tool 25. This arrangement will reduce tooling time, and on the other hand a saving of space is attained, since the support plate 2 itself, with a mounted tool 25, will require a smaller space than a stationary tool.

All disclosed characteristics can be important to the invention. In the disclosure of the application are included the disclosed contents of the corresponding/enclosed priority documents (abstract of a previous application) including full contents, also with the aim of including characteristics of these documents in claims of the above application.

It should be understood that various changes and modifications to the presently preferred embodiments described herein will be apparent to those skilled in the art. Such changes and modifications can be made without departing fron the spirit and scope of the present invention. It is therefore intended that such changes and modifications be covered by the appended claims.

1-15. (canceled)

16. A tool assembly comprising a gripping structure on an underside of a support plate for gripping between two jaws of a gripping table, wherein the support plate supports an electromotor drive assembly on the underside and a tool worked by the electromotor drive assembly extends to an opposed upper side of the support plate, wherein
the support plate is a surface plate from whose downwardly facing underside the gripping structure and the electromotor drive assembly extend in such a way that they project through a space between the two jaws.

17. A tool assembly according to claim 16, wherein the surface plate has opposite elongated edges which each lie flat on a respective jaw of the two jaws.

18. A tool assembly according to claim 16, wherein the support plate has a support surface having approximately half a width of the jaw.

19. A tool assembly according to claim 16, wherein the tool is a milling cutter, and a shaft driving the milling cutter projects through an opening in the surface plate.

20. A tool assembly according to claim 16, wherein the electromotor drive assembly is secured to the underside by a releasable fastener.

21. A tool assembly according to claim 16, wherein the gripping structure on the underside of the surface plate comprises small fastened blocks.

22. A tool assembly according to claim 21, wherein each small block has a projection, which in a gripped configuration engages the jaws from below.

23. A tool assembly according to claim 21, wherein the small blocks comprise four individual small blocks that are spaced from one another and occupy comers of a theoretical rectangle.

24. A tool assembly according to claim 21, wherein the small blocks occupy comers of a right-angled triangle.

25. A tool assembly according to claim 21, wherein the small blocks are made of plastic and are fastened using screws on the underside of the support plate.

26. A tool assembly according to claim 22, wherein the projection comprises spaced-apart noses.

27. A tool assembly according to claim 16, further comprising workpiece guide stops on the upper side of the surface plate.

28. A tool assembly according to claim 27, wherein the workpiece guide stops are adjustable and fixable with respect to the support plate.

29. A tool assembly according to claim 16, further comprising a chip suction hub adjacent a tool opening through the support plate.

30. A tool assembly according to claim 29, further comprising an opening located below the chip suction hub for receiving a chip suction tube.
